(19) United States
(12) Patent Application Publication
(10) Pub. No.: US 2004/0105461 A1
(43) Pub. Date: Jun. 3, 2004

(54) Remote sharing of CCTV control ports for network users

(76) Inventors: Albert Pan, San Jose, CA (US); Henry Jen, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/234,776

(22) Filed: Sep. 3, 2002

(51) Int. Cl. H04J 3/16

(52) U.S. Cl. 370/466

(57) ABSTRACT

A control device is provided to share data communication ports and control Close Circuit Televisions (CCTVs) Matrix Switches for network users. The control device issues a command to a Central Command Dispatch Server (CCDS). The control device identifies a best route to dispatch the command. The control device dispatches the command to a CCTV matrix switch via an appropriate data communication port according to the best route.

### FIELD OF THE INVENTION

This invention relates to a Close Circuit Television (CCTV) control system. In particular, this invention relates to sharing data communication ports and controlling CCTVs for network users.

### BACKGROUND OF THE INVENTION

Close Circuit Television (CCTV) matrix switch is a video camera control equipment that can switch an input video signal to an output monitor port. The CCTV matrix switch can also perform a Pan/Tilt/Zoom (PTZ) control at a camera. The CCTV matrix switch is used when multiple users share input video cameras and limited monitors to view a video image. The traditional CCTV matrix switch is designed for a single user for each serial port of the CCTV matrix switch.

FIG. 1 is a system diagram of one embodiment of a traditional CCTV control system. Referring to FIG. 1, a plurality of local users are connected with a CCTV matrix switch 140 in parallel. Each local user is directly connected with the CCTV matrix switch 140 via a serial port. For example, a local user 110 is directly connected with the CCTV matrix switch 140 via a serial port 110A, a local user 120 is directly connected with the CCTV matrix switch 140 via a serial port 120A, and a local user 130 is directly connected with the CCTV matrix switch 140 via a serial port 130A. One disadvantage of the traditional CCTV control system of FIG. 1 is that the number of local users is limited by the number of available serial ports. Another disadvantage of the traditional CCTV control system of FIG. 1 is that local users are limited by a physical distance of the serial ports.

FIG. 2 is a system diagram of another embodiment of a traditional CCTV control system. Referring to FIG. 2, a local user 210, a local user 220, and a local user 230 are connected with a CCTV matrix switch 240 in serial via a serial port 235. Although the local users 210, 220, and 230 can share one serial port 235, a special protocol must be designed to allow multiple local users to communicate with the CCTV matrix switch 240 via the serial port 235. However, the number of local users is limited by the special protocol design. Again, the disadvantages of the traditional CCTV control system of FIG. 2 are the limitation of the number of available serial ports and the limitation of the physical distance of the serial ports.

Therefore, it is necessary for multiple users to share a limited number of serial ports. It is also necessary that a network user as well as a local user can control a CCTV matrix switch without the limitation of the physical distance of the serial ports.

### SUMMARY OF THE INVENTION

A system and method for sharing data communication ports and controlling Close Circuit Televisions (CCTVs) for network users is described. In one embodiment of the invention, the system and method comprises issuing a command to a Central Command Dispatch Server (CCDS), identifying a best route to dispatch the command, and dispatching the command to a CCTV matrix switch via an appropriate data communication port according to the best route.

Other features and advantages of the present invention will be apparent from the accompanying drawings, and from the detailed description, which follows below.

### BRIEF DESCRIPTION OF THE DRAWINGS

The present invention is illustrated by way of example and not intended to be limited by the figures of the accompanying drawings in which like references indicate similar elements and in which:

FIG. 1 is a system diagram of one embodiment of a traditional CCTV control system.

FIG. 2 is a system diagram of another embodiment of a traditional CCTV control system.

FIG. 3 is a system diagram of one embodiment of a CCTV control system for network users sharing serial ports.

FIG. 4 is a flow diagram illustrating one embodiment of a process for network users to execute a command with a CCTV control system.

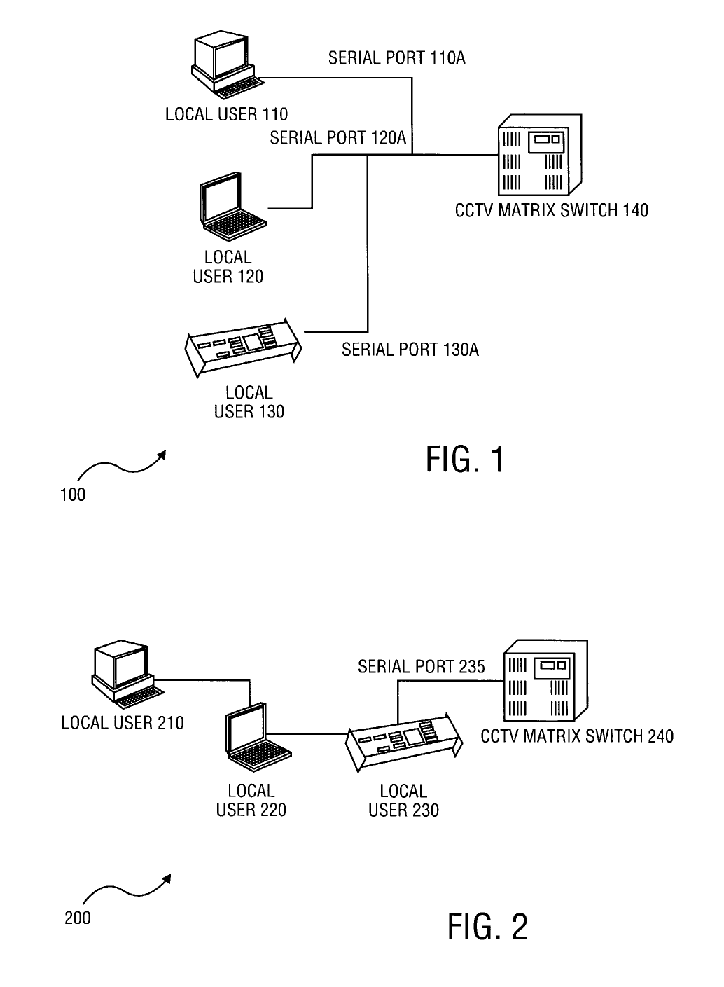

### DETAILED DESCRIPTION

A method and apparatus for sharing data communication ports and controlling CCTV matrix switches is described. In the following detailed description of embodiments of the invention, reference is made to the accompanying drawings in which like references indicate similar elements, and in which are shown by way of illustration specific embodiments in which the invention may be practiced. These embodiments are described in sufficient detail to enable those of ordinary skill in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

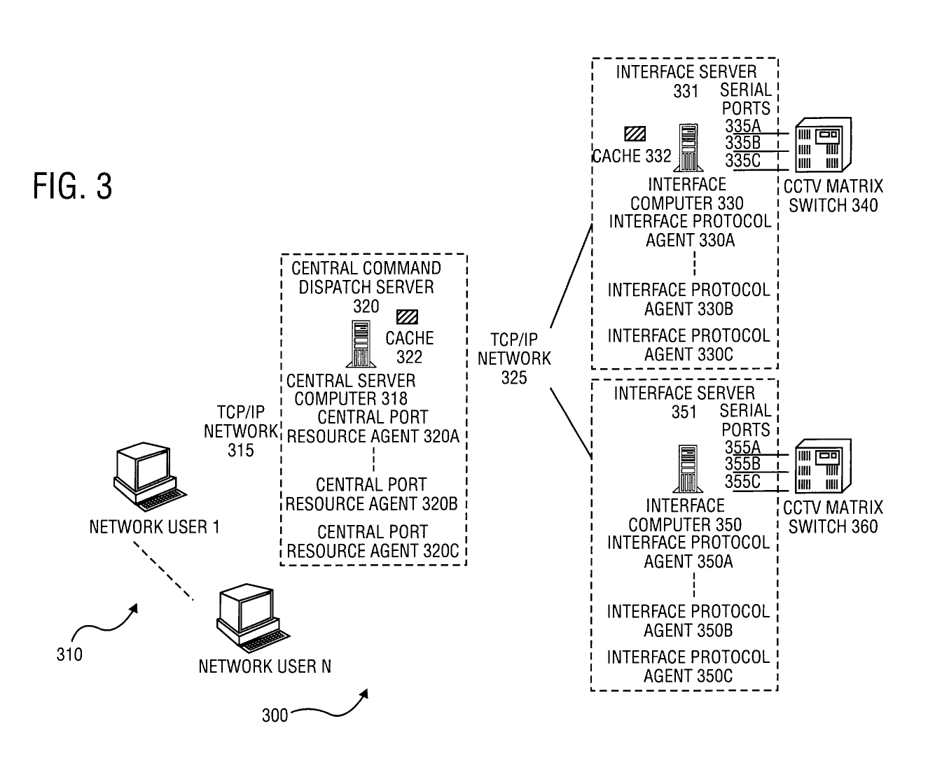

FIG. 3 is a system diagram of one embodiment of a CCTV control system for network users sharing serial ports. Referring to FIG. 3, network users 310 are connected with a Central Server Computer (CSC) 318 via a conventional data network, such as one using the well-known Transmission Control Protocol/Internet Protocol (TCP/IP), so that the network users 310 can communicate with the CSC 318 via an Internet connection. The CSC 318 can be connected with one network user or as many network users as necessary. In one embodiment, the CSC 318 provides a Central Command Dispatch Server (CCDS) 320 for the network users. The CCDS 320 includes a plurality of Central Port Resource Agents (CPRAs) 320A, 320B, 320C, etc. Each CPRA represents a remote serial port. In addition, each CPRA includes a usage information of the remote serial port.

In one embodiment, the CSC 318 is connected with a plurality of Interface Computers 330, 350, etc. via a TCP/IP network 325. Each Interface Computer provides an Interface Server. For example, the Interface Computer 330 provides an Interface Server 331, and the Interface Computer 350 provides an Interface Server 351. In one embodiment, the CCDS 320, and the Interface Server 331 can be run on a single machine or a computer. In another embodiment, the CCDS 320, and the Interface Server 331 can run on separate machines or computers. Each Interface Server includes a plurality of Interface Protocol (IP) agents. For example, the Interface Server 331 includes IP agents 330A, 330B, 330C, etc., and the Interface Server 351 includes IP agents 350A, 350B, 350C, etc. In addition, each Interface Computer is connected with a CCTV matrix switch via serial ports. For example, the interface computer 330 is connected with a CCTV matrix switch 340 via serial ports 335A, 335B, and 335C, etc., and the Interface Computer 350 is connected with a CCTV matrix switch 360 via serial ports 355A, 355B, and 355C, etc.

In one embodiment, the CCTV matrix switches 340 and 360 are the same brand of CCTV matrix switch. In another embodiment, the CCTV matrix switches 340 and 360 are different brands of CCTV matrix switch.

As discussed above, the CPRA represent a remote serial port. In one embodiment, the CPRAs 320A, 320B, and 320C represent the serial ports 335A, 335B, and 335C, respectively. In addition, the CPRA includes a usage information of the serial port which is represented by the CPRA. For example, the CPRA 320A maintains a current usage information of the serial port 335A. In another embodiment, the CPRAs 320A, 320B, and 320C represent the serial ports 355A, 355B, and 355C, respectively. Therefore, a one-to-one representation is established between the CPRAs and the serial ports. Thus, when the network users 310 issue a command, the CCDS 320 can identify an appropriate serial port to relay the command from the network users 310 to the CCTV matrix switch via an appropriate serial port by managing the CPRAs 320A, 320B, and 320C, etc. The network users 310 can choose and share limited serial ports to control the CCTV matrix switches. In addition, the network users 310 can control the CCTV matrix switches without the limitation of physical distance of the serial ports. The detailed description that follows illustrates the method to manage the CPRAs and to execute a command within the CCTV control system 300.

In one embodiment, the CCTV control system 300 includes a cache scheme to improve a CCTV control performance. Typically, the CCTV matrix switch maintains certain context of a latest camera input and monitor output information. When the network users 310 control different cameras, the CSC 318 and the interface server can use the cache scheme to reduce an overhead of camera PTZ control from switching camera input and monitor output. In one embodiment, the CCDS 320 includes a cache 322 to reuse one of the CPRAs if the corresponding camera input is same. In another embodiment, the Interface Computer 330 includes a cache 332 to avoid a duplicated camera input and monitor output switching.

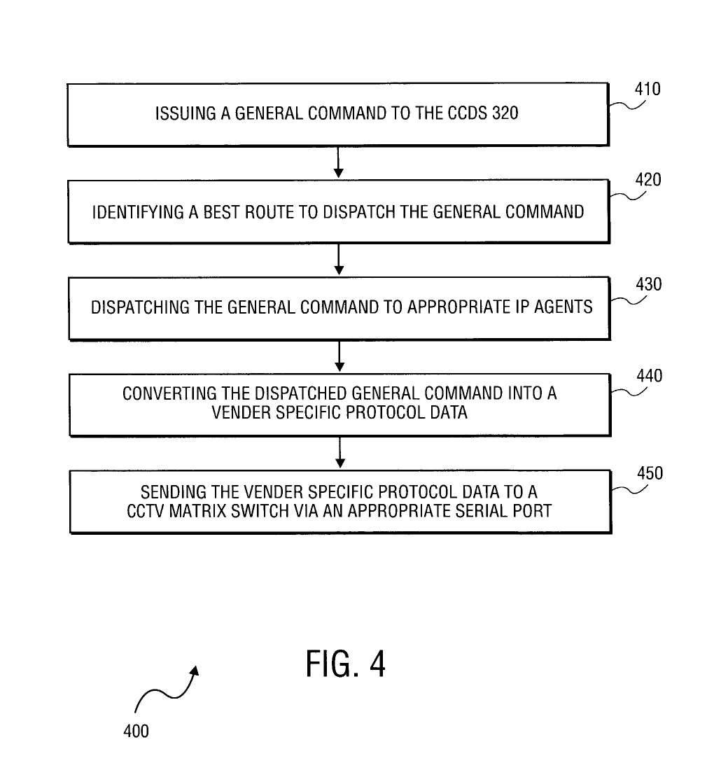

FIG. 4 is a flow diagram illustrating one embodiment of a process for the network users to execute a command within the CCTV control system 300. At processing block 410, the network users 310 issues a general command to the CCDS 320 via the TCP/IP network 315. At processing block 420, the CCDS 320 receives the general command and identifies a best route for dispatching the general command. In one embodiment, the CCDS 320 identifies the best route by a weighted-routing approach. The CCDS 320 uses a weighted-routing algorithm to query the CPRAs 320A, 320B, 320C, etc., so that the CCDS 320 can identify an appropriate serial port by calculating weights of each serial port.

At processing block 430, the CCDS 320 dispatches the general command to the IP agents of the interface computers 330/350 according to the best route. In one embodiment, if the CCDS 320 identifies that the serial port 335A is the best route to relay the command, the CCDS 320 dispatches the general command to the IP agent 330A. At processing block 440, the IP agent 330A converts the general command into a vendor specific protocol data. At processing block 450, the interface computer 330 sends the vendor specific protocol data to the CCTV matrix switch 340 via the serial port 335A. In another embodiment, if the CCDS 320 identifies that the serial port 355B is the best route, the command will be dispatched to the IP agent 350B and sent to the CCTV matrix switch 360 via the serial ports 355B. Thus, when one of the network users 310 issues a command, the command will be executed via a remote appropriate serial port. In addition, the number of network users is not limited by the number of serial ports. Therefore, the multiple network users 310 share the limited serial ports to control the CCTV matrix switches.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. An apparatus comprising:
a Central Command Dispatch Server (CCDS) receiving a general command from a plurality of network users and identifying a best route to dispatch the general command;
an interface server receiving the dispatched command from the CCDS and converting the dispatched command into a vendor specific protocol data; and
a Close Circuit Television (CCTV) matrix switch receiving the vendor specific protocol data from the interface server via data communication ports, so that the network users can share the serial ports.

2. The apparatus of claim 1, wherein the CCDS includes a plurality of Central Port Resource Agents (CPRAs).

3. The apparatus of claim 2, wherein each CPRA represents one of the data communication ports.

4. The apparatus of claim 3, wherein the CPRA includes a usage information of the data communication port.

5. The apparatus of claim 2, wherein the CCDS identifies the best route by querying the CPRAs.

6. The apparatus of claim 5, wherein the CCDS dispatches the general command to an appropriate data communication port according to the best route.

7. The apparatus of claim 2, wherein the CCDS includes a cache to reuse the CPRA.

8. The apparatus of claim 1, wherein the interface server includes a cache to avoid a duplicated camera inputs and monitor output switching.

9. The apparatus of claim 1, wherein the CCDS and the interface server are included in a computer.

10. A method comprising:
issuing a command to a Central Command Dispatch Server (CCDS);
identifying a best route to dispatch the command; and
dispatching the command to a Close Circuit Television (CCTV) matrix switch via an appropriate data communication port according to the best route.

11. The method of claim 10, further comprising converting the command into a vender specific protocol data.

12. The method of claim 10, further comprising sharing data communication ports by a plurality of network users.

13. The method of claim 10, wherein the CCDS includes a plurality of Central Port Resource Agents (CPRAs).

14. The method of claim 13, wherein the CPRA includes a usage information of the data communication port.

15. The method of claim 13, wherein identifying the best route includes querying the CPRAs.

16. The method of claim 13, wherein the CCDS includes a cache to reuse the CPRA.

17. An apparatus comprising:
a Central Command Dispatch Server (CCDS) receiving a command;
means for identifying a best route to dispatch the command; and
means for dispatching the command to a Close Circuit Television (CCTV) matrix switch via an appropriate data communication port according to the best route.

18. The apparatus of claim 17, further comprising means for converting the command into a vender specific protocol data.

19. The apparatus of claim 17, further comprising means for sharing data communication ports by a plurality of network users.

20. The apparatus of claim 17, wherein the CCDS includes a plurality of Central Port Resource Agents (CPRAs).

21. The apparatus of claim 20, wherein the CPRA includes a usage information of the data communication port.

22. The apparatus of claim 20, wherein the means for identifying the best route includes means for querying the CPRAs.

23. The apparatus of claim 20, wherein the CCDS includes a cache to reuse the CPRA.

24. A computer readable medium containing executable instruction which, when executed in the process system, causes the system to perform a method for sharing data communication ports by a plurality of network users, the method comprising:
issuing a command to a Central Command Dispatch Server (CCDS);
identifying a best route to dispatch the command; and
dispatching the command to a Close Circuit Television (CCTV) matrix switch via an appropriate data communication port according to the best route.

25. The computer readable medium of claim 24, further comprising converting the command into a vender specific protocol data.

26. The computer readable medium of claim 24, wherein the CCDS includes a plurality of Central Port Resource Agents (CPRAs).

27. The computer readable medium of claim 26, wherein the CPRA includes a usage information of the data communication port.

28. The computer readable medium of claim 26, wherein identifying the best route includes querying the CPRAs.

29. The computer readable medium of claim 26, wherein the CCDS includes a cache to reuse the CPRA.
